(19) United States
(12) Patent Application Publication
(10) Pub. No.: US 2012/0225785 A1
(43) Pub. Date: Sep. 6, 2012

(54) Automated Storage of a Discrete Sample Among Multiple Samples And Automated Selection of Such Discrete Sample for Processing

(76) Inventor: Chiu W. Chau, Edison, NJ (US)

(21) Appl. No.: 13/410,816

(22) Filed: Mar. 2, 2012

Related U.S. Application Data
(63) Continuation-in-part of application No. 13/017,213, filed on Jan. 31, 2011.
(60) Provisional application No. 61/555,528, filed on Nov. 4, 2011.
(60) Provisional application No. 61/311,825, filed on Mar. 9, 2010.
(60) Provisional application No. 61/407,179, filed on Oct. 27, 2010.
(60) Provisional application No. 61/410,045, filed on Nov. 4, 2010.

(51) Int. Cl. C40B 20/00

(52) U.S. Cl. 506/2

(57) ABSTRACT

Automation of sample storage with a pipetting and nucleic acid adsorption system, which stores a patient nucleic acid sample in an identified location. In the event of system failure or interruption, software included as part of the system notes throughout the process, the stage and the sample(s) position through a tracking process. The software then generates a new set of commands for the system, based on the system's stage and the samples' position, so that the process resumes from the interruption point forward.

### BACKGROUND

Use of nucleic acid adsorbing solid phase products, as disclosed in U.S. application Ser. Nos. 13/019,511 and 13/017,213 (by Chiu Chau, assigned to BioSample LLC, hereby incorporated by reference), can permit automated extraction of DNA (or RNA) from a sample, and then PCR of the adsorbed nucleic acid, as the first step in the nucleic acid analysis. There are several steps in this sample analysis, including: adsorbing nucleic acid to the solid phase, adsorption of sample, washing of solid-phase carrier to remove excess sample, and then PCR. These steps could be more readily automated if they are performed in a pipette channel, where the pipette channel houses the products, and where the sample, and all reagents and solutions, are drawn into the pipette channel through its tip in a normal pipetting action.

U.S. application Ser. Nos. 13/019,511 and 13/017,213 describe that PCR can be performed directly on the carrier containing the extracted DNA or RNA, without the need for elution. However, one can also perform PCR (and further analysis) on a solution containing nucleic acid eluted from the product. Elution of nucleic acid may be preferable if one can elute a predictable quantity of nucleic acid for PCR and analysis, without having to remove the s solid-phase carrier from inside the pipette tip. In such case, one eliminates a step of removing the carrier from the pipette to analyze the nucleic acid.

For a typical processing procedure, a blood sample is drawn from a patient into a blood tube, then transferred from the blood tube into a particular well of a multi-well plate, such as a 96-well plate, prior to processing or analyzing it. As a number of samples are generally being processed together, each will be transferred from its tube into a different well in the plate, and their location identified by some method. If the nucleic acid in the samples is to be stored for processing at a later time, as is often the case, considerable time and effort (as well as reducing errors associated with incorrectly identifying samples) can be accomplished if there is an automated system for: (i) tracking which sample is in which well, and (ii) extracting the sample from the well for processing at the appropriate time.

### SUMMARY

Disclosed is an automated system for processing multiple samples which are in turn then each stored in a designated location, for automated retrieval. Processing samples with the system involves multiple steps, including: extracting a blood sample from a tube and storing it along with multiple other samples each at a discrete identified location. Positional tracking and recording of sample location also allows, for the particular sample(s) being extracted/deposited, software (which is included as part of the process) to automatically generate a new set of commands to continue the remainder of the process from the termination point forward.

Preferably, the samples are adsorbed to a solid-phase carrier (more preferably, to the solid-phase carrier described in U.S. application Ser. Nos. 13/019,511 and 13/017,213) for long term storage, and each solid-phase carrier with the adsorbed sample is stored at a known and identified location. Alternatively, the sample adsorbed to the solid-phase carriers can be analyzed immediately, and not stored.

Additional steps in the processing of the samples can include transferring the samples from tubes to a multi-well plate, then extracting blood from the multi-well plate for adsorption to a solid-phase carrier for storage (in a designated location) followed by analysis, or for immediate analysis without storage.

The system described herein is suitable for storing multiple individual samples for immediate or later analysis in a number of different settings, including forensics and medicine. A sample can be taken early in a patient's life, for example, and stored for subsequent analysis as diagnostic tests become more widely available or feasible. It would also be readily applicable in blood or organ donation centers, where multiple samples are stored.

A software feature of the automated system tracks and records the location of each sample throughout the process (note that the system is for processing multiple samples). The location of the tube with the sample is first noted and recorded, and then the location of the extraction device(s) which extracts that sample from the start of the process, i.e., from each tube and then from each well, is tracked and recorded. The location of each sample is preferably depicted like a map of the process in chronological sequence with sample locations indicated at any time point accessed. The map can preferably be accessed using an icon.

If the sample extraction and deposition cycle is terminated before completion (i.e., before the sample is placed in its ultimate storage or analysis location) due, for example, to the lack of a suitable uncontaminated tip being available for the extraction device, or a power loss, or otherwise if there is interruption or system failure during the process, the positional tracking and recording allows the device to re-start at the correct place and with the correct sample(s). The positional tracking and recording also allows use of software to automatically generate a new set of commands to continue the remainder of the process from the termination point forward. The generation of the new set of commands is preferably controlled by the user, using the map icon or another icon.

By virtue of the positional tracking and recording and the software which automatically generates a new set of commands to continue the remainder of the process from the termination point forward, the system will not inadvertently contaminate or lose any samples if the processing cycle is terminated before completion for any reason. Without location tracking and automated generation of commands for continuation, the process would need to re-start from the beginning if interrupted, and samples already processed and deposited would need to be discarded (as their location had not been tracked and identified).

An additional feature of the software is that the user can select particular samples in particular tubes or plates for storage at a designated location and/or immediate analysis. Using the map, the user indicates the samples for action (and their location), the processes to be performed on those samples, and then initiates a set of commands specific to those samples. Again, this feature is preferably shown on the same icon as the map or on a different icon.

### BRIEF DESCRIPTION OF THE DRAWINGS

FIG. 1 is an elevational view of the features of a robot for automated selection and storage of a discrete sample, extracted from a blood tube and adsorbed to a solid-phase carrier such that the Sample nucleic acid material can be stored and subsequently processed.

FIG. 2 is an overhead view of the robot of FIG. 1.

FIG. 3 is a frontal view of the robot of FIG. 1.

FIG. 4 is a frontal view of showing the overhead movable rack positioned so the pipettes take new tips from a lower rack.

FIG. 5 shows the section shown in FIG. 4 where the pipettes are taking new tips from the lower rack.

FIG. 6 shows the section shown in FIGS. 4 and 5 after the pipette tips are taken from the lower rack.

FIG. 7 shows the overhead movable rack positioned above a rack of test tubes.

FIG. 8 shows the overhead movable rack in the same position as in FIG. 7 with the pipettes lowered to deposit their contents into the individual test tubes.

FIG. 9 shows the overhead movable rack positioned above a well plate.

FIG. 10 shows the overhead movable rack positioned above a rack designed for tip removal.

FIG. 11 shows the overhead movable rack lowered to remove the tips.

FIG. 12 shows the overhead movable rack raised after removal of the tips.

### DETAILED DESCRIPTION

Automation of sample storage is more easily implemented where blood tubes (or blood bags) with samples are first transferred to a planar storage medium, like a 96 well plate. Thus, in a first embodiment, the first step in the automated system is transferring each of a number of blood or tissue samples, each of which is housed in a particular tube or other container, each to a particular well of a 96 well plate, or to a particular well of another type of well plate, or to a particular container in an array of accessible containers. The wells in the planar surface can be accessed more readily by an automated extraction system.

In contrast to automation with a planar storage medium, if the blood remains in blood tubes, as it would be following withdrawal, then in an automated system using extraction devices (including pipettes), as envisioned here, the extraction devices would need to be center positioned accurately before moving down for sample extraction (to avoid contact with the sides of the tubes), and then would need to move up and over lips of the tubes after each extraction, before being placed in position for sample extraction or deposition at the next location in the automated sequence. With a 96 well plate or other planar container, the centering of the extraction devices does not need to be as accurate and the extraction devices do not need to move up and over the edges of tubes and back into position. Thus, less exactitude in positioning the extraction devices is needed in the automation steps.

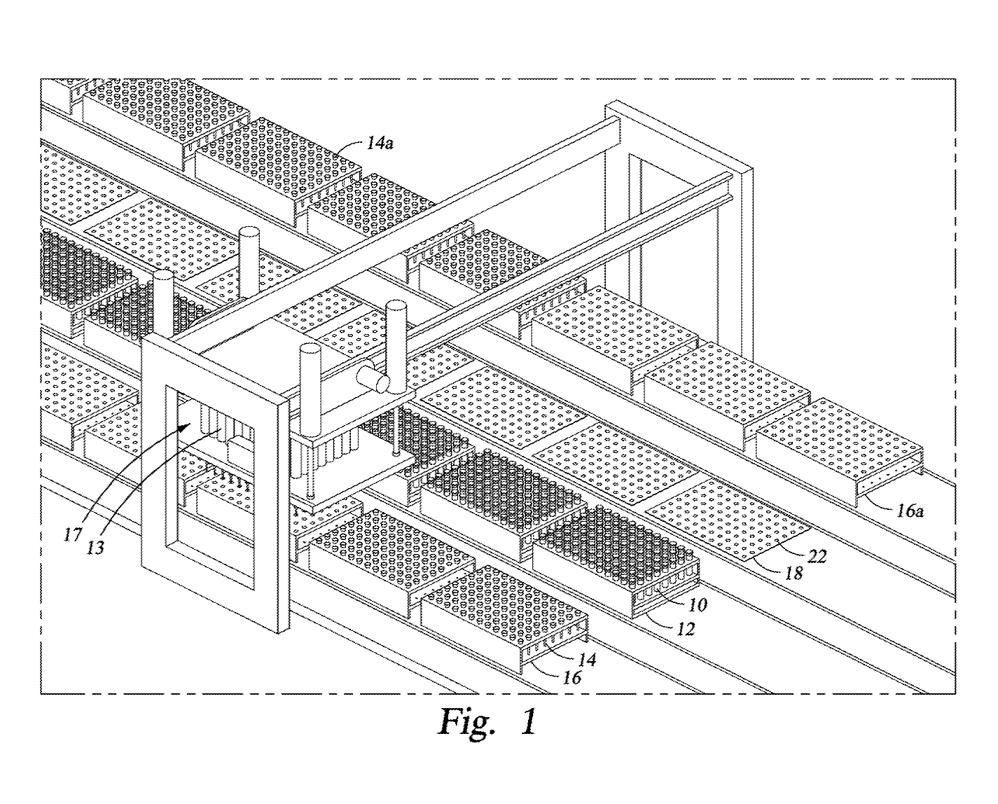

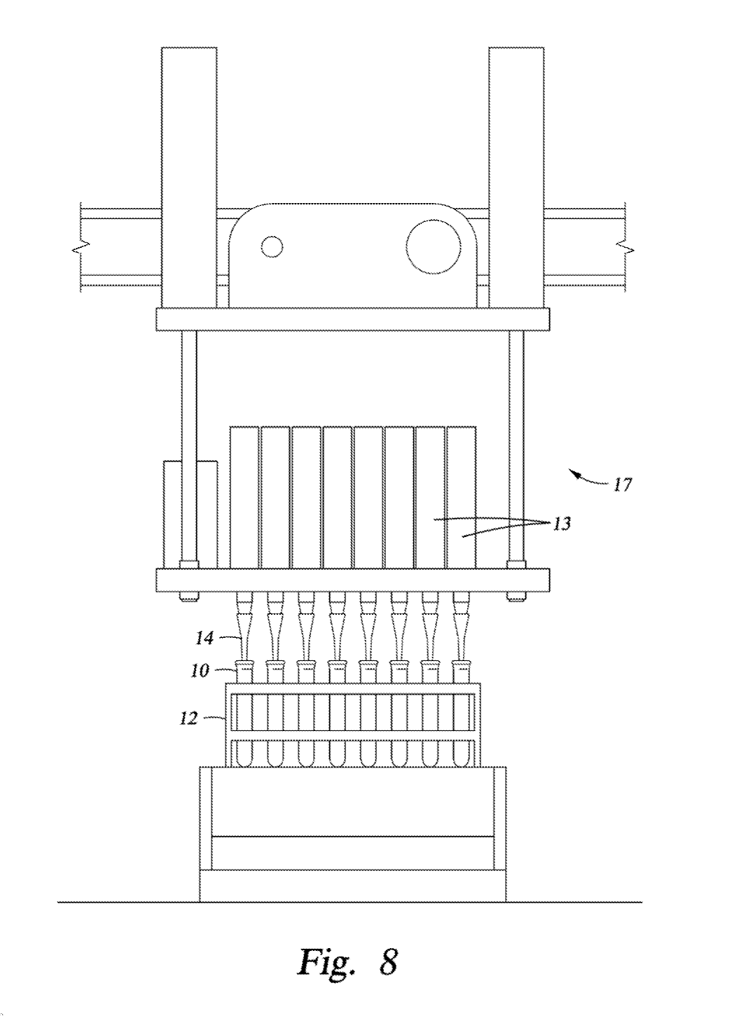

A preferred way to automate the first step in the process is by having a rack of blood tubes, each with a patient sample, in fixed positions in an array. Referring to FIG. 1, blood tubes 10 are positioned in rack 12 in a matrix arrangement. Blood from a particular tube 10 in the matrix can be selected using an automated extraction device, such as a pipette 13 with a pipette tip 14. In FIG. 1, the pipettes 13 are in a grid arrangement positioned on an overhead movable rack 17, where the pipettes 13 in the grid have positions corresponding to each of the blood tubes 10 in the matrix. The overhead rack 17 is positioned so that the pipettes 13 are above the upper end of the corresponding blood tubes 10, such that a particular pipette 13 in the grid can extract blood from a particular tube 10 in the matrix when the entire rack 17 is lowered into the extraction position (as in FIG. 8). Following automated extraction with the pipettes 13 in the grid, whereby each pipette 13 would then hold a sample from one of the tubes 10, the entire rack of pipettes 13 is raised above the height of the top of the tubes 10.

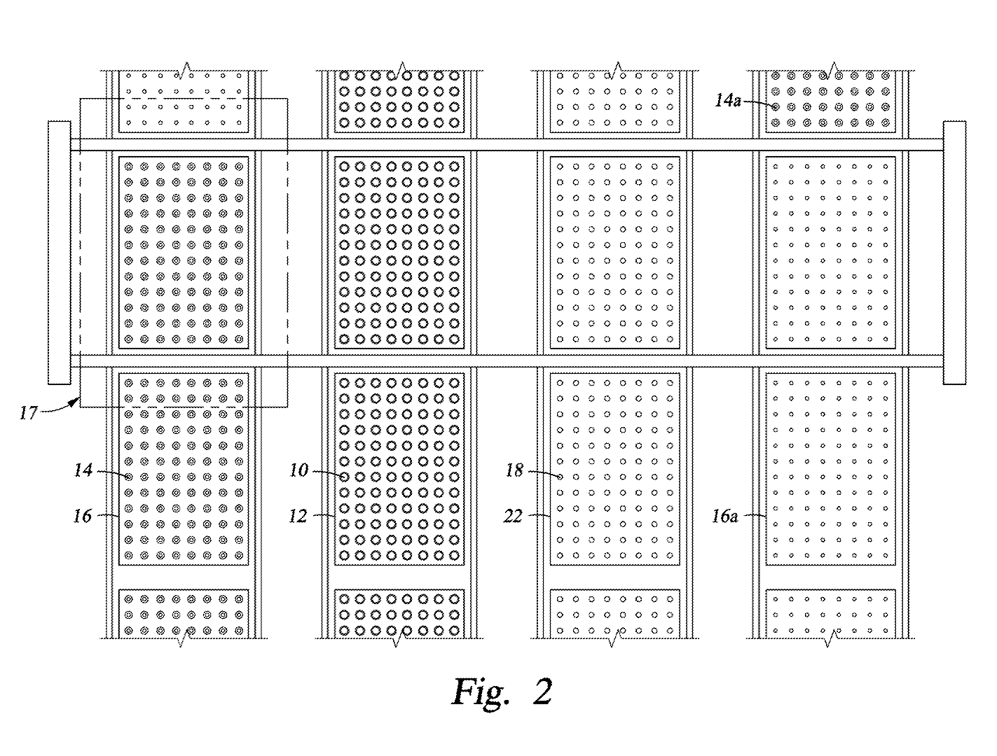

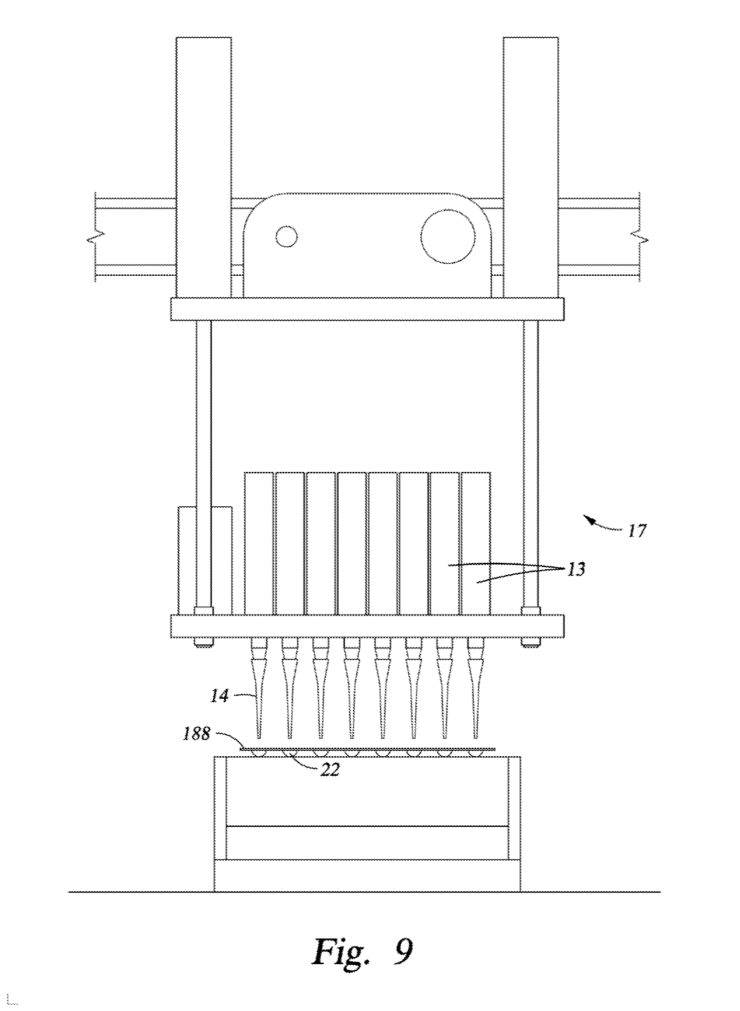

The rack of pipettes 13 is then preferably positioned as in FIG. 9 to deposit the samples into a planar array of wells 22 (as shown in FIG. 2), such as a multi-well plate 18, and the pipettes are automatically actuated to make the sample deposits in the appropriate well locations. Optionally, this step can be eliminated, if the pipettes holding samples already contain the adsorbing tip (described below). In such case, the adsorbing tip can be deposited directly in a defined location for storage and later access, or the adsorbed sample can be immediately processed, as desired.

Each sample in the array is then extracted, from the array of containers (which are preferably wells in a planar well plate 18), and stored in an identified location, and preferably in a form which can be readily analyzed and/or in a form where the nucleic acid therein can be readily amplified. The extraction of samples can be performed by extracting a particular sample from a particular well 22 using a selected one (or more) of a plurality of extraction devices (e.g., pipettes 13) wherein the selected extraction device is automatically guided to the particular well 22 holding the sample for extraction, and the extraction device withdraws sample on actuation. Following withdrawal of each sample with the extraction device, the following steps are performed:

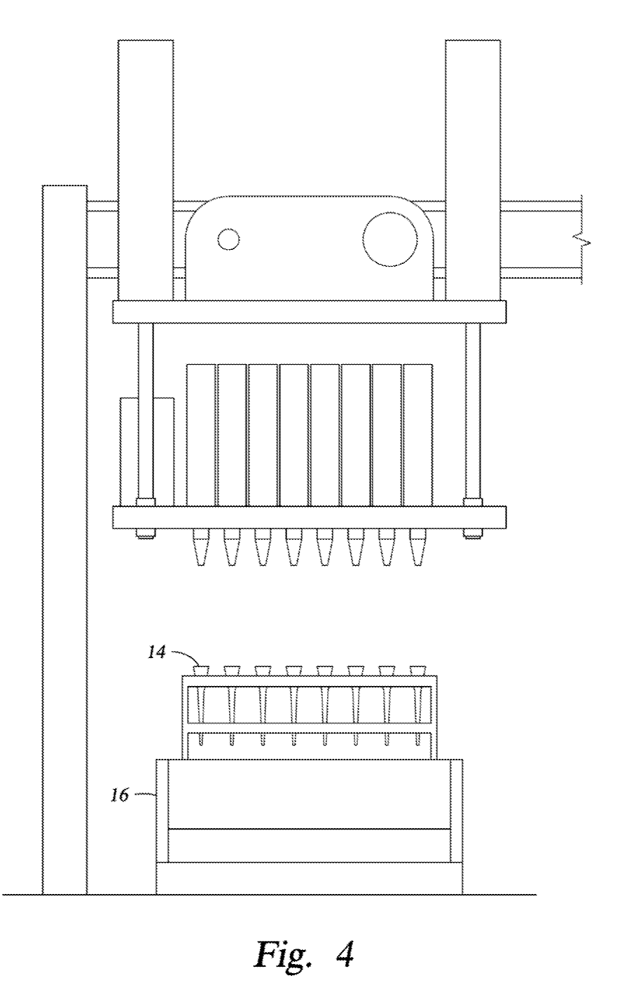

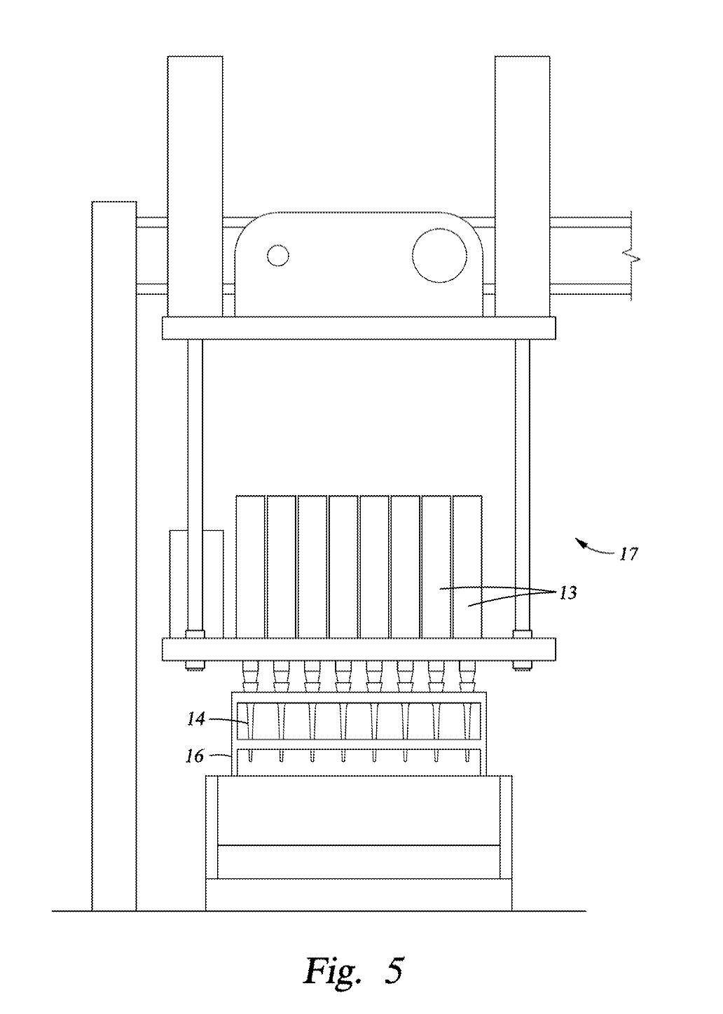

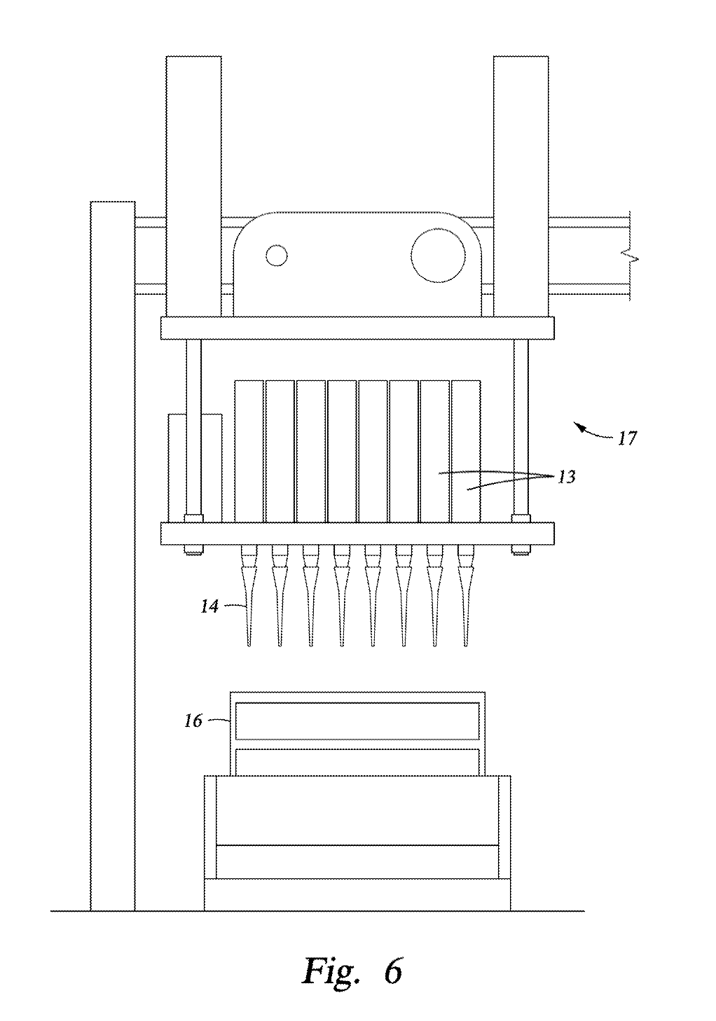

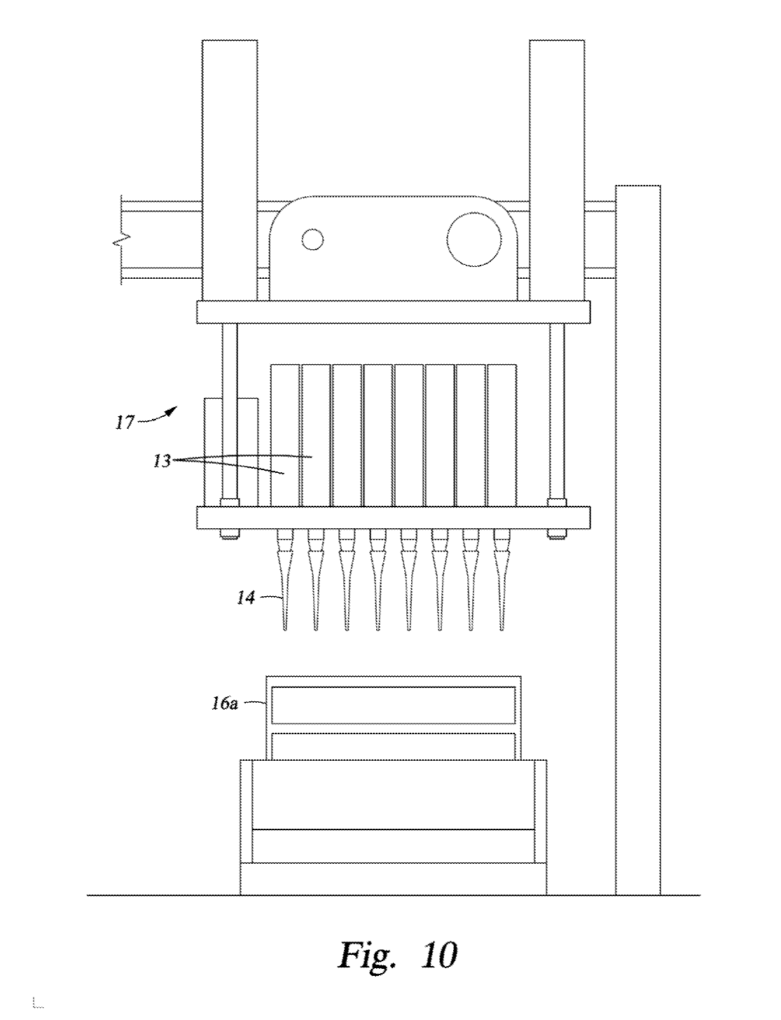

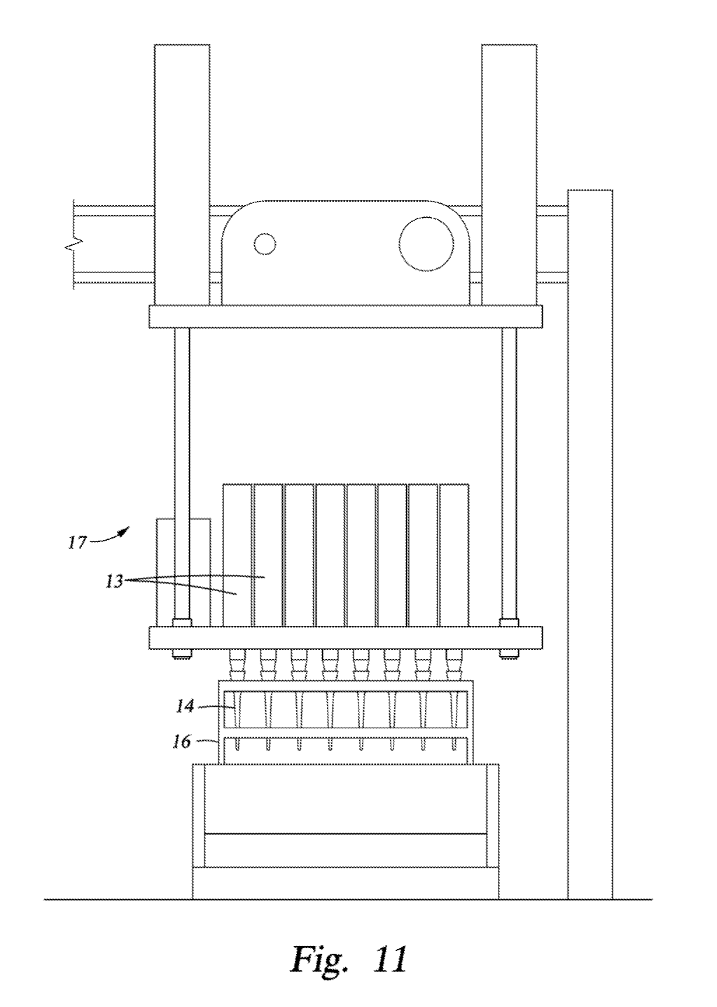

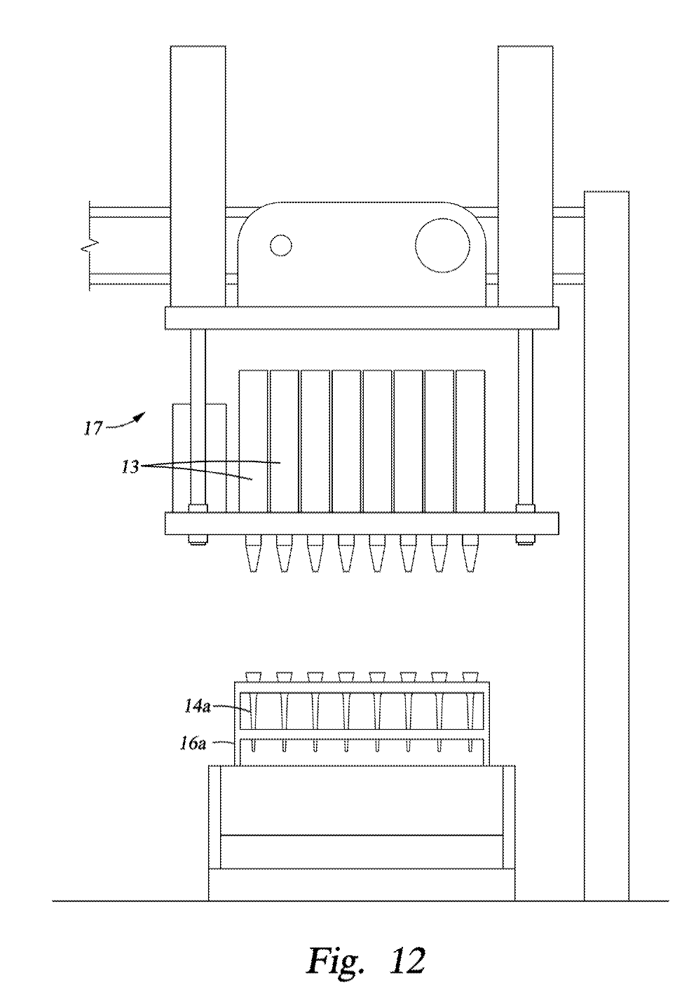

removing the tip which contacted the sample from the selected extraction device (see FIGS. 10-12);
adding an adsorbing tip to the selected extraction device, which is a tip which contains a carrier, preferably a solid-phase carrier, that adsorbs nucleic acid from the sample contained in the extraction device (see FIGS. 4-6);
guiding the extraction device to a storage or analysis location, and removing the adsorbing tip from the selected extraction device and placing the adsorbing tip at a designated location; and
repeating the steps for the next sample in sequence.

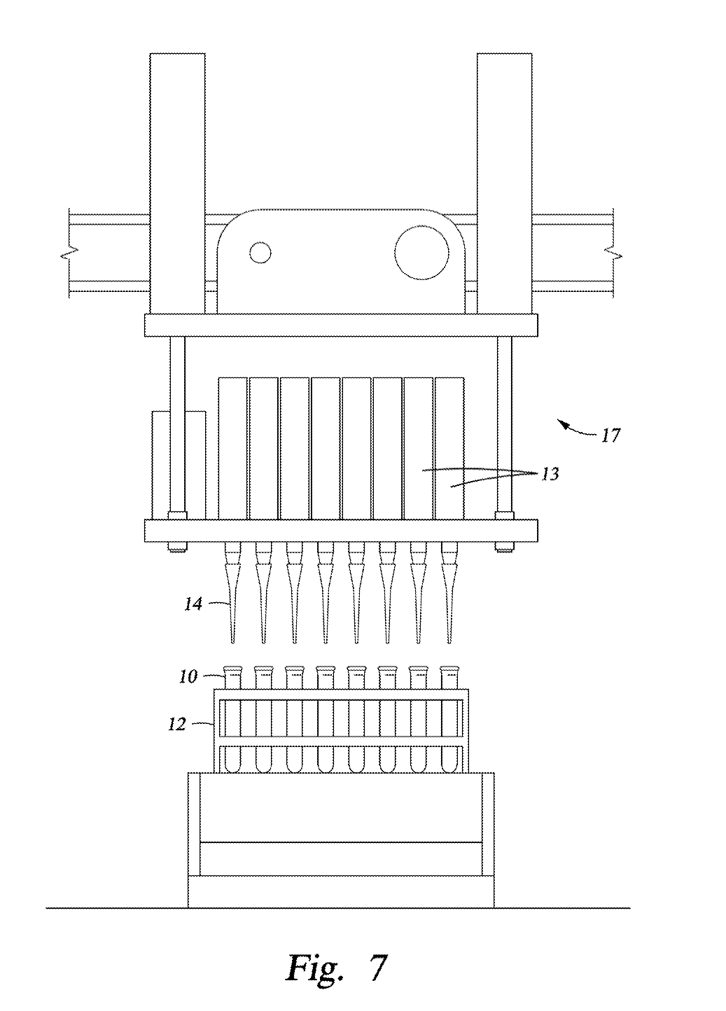

The process above is depicted in the figures, where the first step in the process of withdrawal of blood from the blood tubes is shown in FIGS. 7 and 8.

In an alternative embodiment, the tip which is used to extract the samples from the tubes is the adsorbing tip. In this alternative embodiment, the tip with the adsorbed sample is then deposited at a defined location for later access or procession. In this alternative embodiment, therefore, it is not necessary to change the tip after sample extraction. All other steps would be the same as outlined above.

The adsorbing tip placed in the designated location at the end of the process includes nucleic acid which can be processed for analysis, e.g., using PCR. If the solid-phase carrier is of the type in U.S. application Ser. Nos. 13/019,511 and 13/017,213, there is no need to elute the nucleic acid before processing it. The nucleic acid in the solid-phase carrier can be amplified by PCR, and then analyzed, with or without elution from the solid-phase carrier, as desired.

The adsorbing tip in the designated location can be selected automatically based on its location, and moved to a location better suited for processing, or processed in position—if, for example, it is located in a well. The amplification of the nucleic acid in the adsorbing tip with PCR, can also be automated—though such an automated PCR system would be separate from the process described herein.

The extraction device(s) which extracts that samples are tracked and recorded from the start of the process, through each cycle to depositing the adsorbing tip, and then the tracking starts again for the location of the next extraction device at the next well. In an alternative embodiment, instead of using a rack of pipettes/extraction devices with each corresponding in location to a sample location, one can have only one pipette or extraction device taking one sample, then moving through all the steps to sample deposition. The process would then re-start for the next pipette and the next sample, until all samples had been processed.

In this alternative embodiment, the location of the tube with the sample is first noted and recorded, and then the location of the extraction device(s) which extracts that sample from the start of the process, i.e., from each tube, and then from each well, in sequence, is tracked and recorded, through to each cycle of depositing the adsorbing tip, and then the tracking starts again for the location of the next extraction device at the next well.

### Exemplary System Using an Overhead Rack of Pipettes

In operation, the pipettes 13 held in the overhead rack 17 first are first positioned over the rack 16 of tips 14, as shown in FIGS. 4-6. In this example, there would be 96 pipettes 13 in the grid corresponding in position to each of the 96 Pipette Tips 14 (each positioned in a corresponding grid below a pipette 13). The pipettes 13 are then lowered onto the tips 14 so a tip is pushed into the end of each of the pipettes 13. Each tip 14 resides in a hole in a plate which is part of rack 16 (FIGS. 4-6), so it is easily removed by the tighter pressure fit when the tapered pipette column is lowered onto the tapered tip, and pressed down. After loading the pipettes with tips, the rack of pipettes 13 is moved into position above the tubes 10 (FIG. 7).

Once in position, a sample is extracted by each pipette (through the tip) by automatically actuating the pipette (FIG. 8), and then the pipettes are moved into position to deposit each sample into a well of the 96 well plate 18 as in FIG. 9 (again by automatic actuation). The location and identity of each sample deposited in the 96 well plate is identified, based on the identity of the pipette 13 which deposited it. The identity and location of the sample is thus maintained when the entire rack 16 of pipettes 13 is moved into position over plate 18 or over a plate where the sample is stored. Other systems of moving the rack of pipettes and a plate of samples so the samples can be processed are also possible, and within the scope of the invention.

Other systems of withdrawing sample from an array of tubes, rather than an overhead rack of pipettes 13, can also be used with the invention. In the alternative embodiment, pipettes could be individually controlled and moved into position over a tube in the array of tubes, lowered, actuated and thereby withdraw sample into the pipette. If the tracking software (described further below) is part of the invention, an individually controlled set of pipettes is feasible and practical, as the location of the pipette and the sample it is holding is always known, recorded and can be retrieved if there is a system failure. In the event of a failure or interruption, the software, based on the location of the samples and the stage of processing, generates a new set of commands automatically and initiates the next step in the sample processing to continue.

The pipettes are preferably automatically actuated to uptake sample into the pipette and expel sample. Automatic actuation can be, for example, with a relay switch which triggers an electromagnet which moves the pipette plunger down to withdraw sample on the upstroke, or to expel sample on the downstroke.

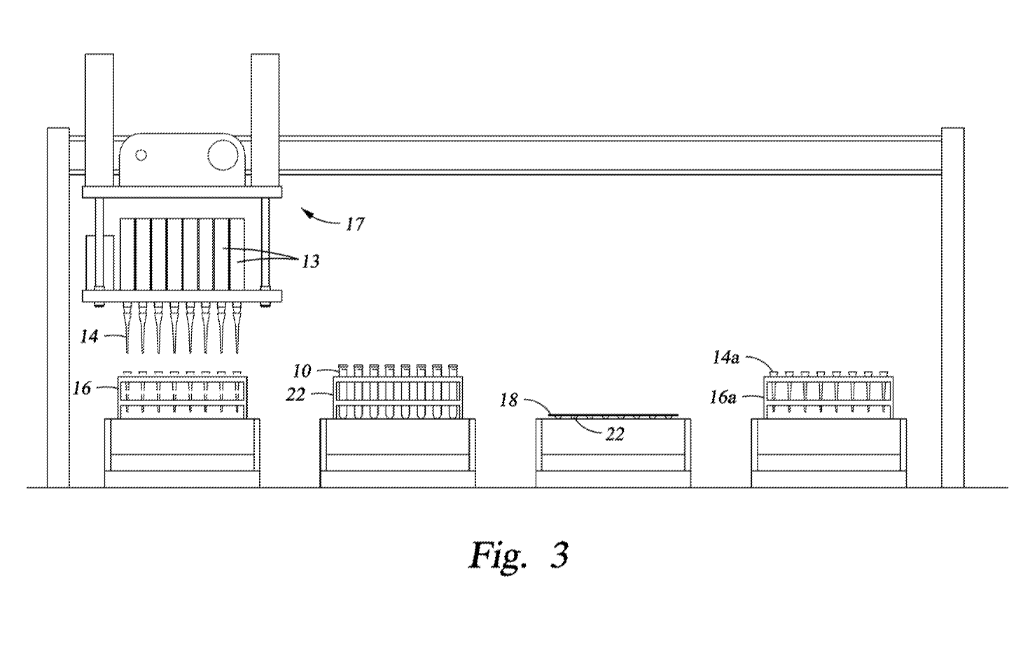

After the sample is deposited into a well of the 96 well plate or other container and before or after the rack of pipettes is moved to a different location for sample deposit and storage (or, before the pipettes are used to withdraw sample from the 96 well plate), the tip is automatically removed from each pipette. Automatic expulsion of the pipette tips is disclosed in U.S. Pat. Nos. 6,749,812; 6,977,062 both incorporated by reference. Tip removal can also be accomplished by moving the pipettes on the rack downwardly so that the pipettes are pushed into a matching array of tapered holes in a plate like that shown in FIGS. 3 to 5 (which is thick enough to generate a tight friction fit). The tips are then removed from the pipette by the friction fit in the tapered holes in the plate in FIGS. 3 to 5 when the rack of pipettes are lifted up and away from the tapered holes.

Returning to the operation of the automated system, in one embodiment the 96 well plate (with the samples in the wells) is moved to a designated position in a different location. Alternatively, the 96 well plate (or other array of containers) remains in the same location, and a different, uncontaminated overhead rack of pipettes is moved into position over the 96 well plate (called “the secondary tube array”). These pipettes in the secondary tube array would preferably contain, in each of their tips, the solid-phase carrier described in Ser. Nos. 13/019,511 and 13/017,213 (as described further below).

Referring again to the figures, in order to adsorb the samples to a solid phase product for storage, the pipettes in the secondary tube array are positioned above the rack of pipette tips 16. Each “Tip” is a pipette tip with the solid-phase carrier described in Ser. Nos. 13/019,511 and 13/017,213 contained in the tip. The pipettes are lowered into position on the tips such that a tip with a solid-phase carrier is pushed into the end of each of the pipettes and the friction fit holds the tip in place when the pipettes in the secondary tube array are lifted up and moved to the next stage.

The rack of pipettes 13 in the secondary tube array is next positioned over the well plate 18, and a sample is drawn from each well 22 into each tip, where the sample contacts the solid-phase carrier, which adsorbs nucleic acid from the sample. The pipettes in the secondary tube array is then automatically positioned to remove the tip and deposit the tip into a over the multi-well plate for storage.

The wells in the DNA extraction plate contain a DNA extraction/elution solution. The nucleic acid adsorbed to the product can be immediately eluted for analysis, or stored for extended periods for elution and analysis at a later time. Elution is performed, for example, with: TE Buffer (consisting of 10 mM Tris, 1 mM EDTA pH 8.0) or 10 mM Tris (at 5-20 μl/product) for DNA elution, or, with RNase free water (water free of any RNA degrading enzymes), at 5-20 μl/product, for RNA elution. PCR and further analysis on the eluted nucleic acid eluted can be performed in the wells of the DNA extraction plate or, in another location—using solution from the DNA extraction plate well.

The tips in multi-well plate for storage can remain there for long term storage, for subsequent DNA extraction and processing, analysis, PCR, or other processes.

Other devices to control the movement of a pipette among stations, uptake and expulsion of sample, uptake and expulsion of washing fluids, and uptake and expulsion of reagents for PCR, are depicted in U.S. Pat. No. 6,938,502 (incorporated by reference). This patent discloses a pipette driving device comprising a vertically movable main arm and an elongated guide arm cantilevered by the main arm and extending horizontally, the guide arm having a smaller flexural rigidity than the main arm, wherein the main arm vertically moves the pipette when the sample is to be sucked up from the sample vessel, and the guide arm guides the pipette to an open vessel and then vertically moves the pipette when the sample is to be discharged into the open vessel. Any of these arrangements could be used to accomplish the same movement of pipettes among locations, and uptake and expulsion of sample, herein.

Software Tracking and Recording

For the sample extraction and storage/processing system shown in the figures, the location of each sample can be tracked throughout the process by tracking of the tube in the initial tube array the sample came from. Because the sample location in the multi-well plates for sample storage corresponds with the location in the tube array 12, which in turn corresponds with the sample location in the secondary tube array used to withdraw sample from the 96 well plate, each sample can be tracked to the secondary tube array based solely on its initial location. Provided the secondary tube array deposits its respective tips (with adsorbed product) into a particular container in another matching array of containers, the location of each adsorbed sample product will be known from knowing the tube the sample came from.

The location of samples can be lost though, where the process in the figures re-starts multiple times, each time with a new rack of tubes with new samples. In such case, if there is a system failure during one of the cycles, the location of the tubes with sample would not be known, unless one had tracking for the processing cycle the system was currently on.

### System Failure and Interruption

In the event of system failure or interruption, software included as part of the system notes throughout the process, the stage and the sample(s) position through the tracking described immediately above. The software then generates a new set of commands for the system, based on the system's stage and the samples' position, so that the process resumes from the interruption point forward. The generation of the new commands can be done automatically or by operator intervention, preferably by the operator initiating the generation of the commands using an icon. The software, and preferably the icon, also allows the operator to view a pictorial representation of the system's stage and the sample's position, so that the operator can determine if the new commands generated are appropriate.

The generation of the new commands and the pictorial representation of the system's stage and the sample's position allows the system to resume from the interruption point so that the entire process does not need to be repeated from the start to the interruption point. This is a significant advantage from a time and cost-savings standpoint.

A number of other arrangements of pipettes automatically tracking sample locations can be envisioned, and are within the scope of the invention. Pipettes could move in single file on one overhead rack through a series of locations to extract samples from wells in plates and then expel the sample into other wells in other plates. The tracking of individual pipettes in the system can be with positional encoding, or RFID tags, or other well known tracking systems.

The specific methods and compositions described herein are representative of preferred embodiments and are exemplary and not intended as limitations on the scope of the invention. Other objects, aspects, and embodiments will occur to those skilled in the art upon consideration of this specification, and are encompassed within the spirit of the invention as defined by the scope of the claims. It will be readily apparent to one skilled in the art that varying substitutions and modifications may be made to the invention disclosed herein without departing from the scope and spirit of the invention. The invention illustratively described herein suitably may be practiced in the absence of any element or elements, or limitation or limitations, which is not specifically disclosed herein as essential. Thus, for example, in each instance herein, in embodiments or examples of the present invention, any of the terms “comprising”, “including”, “containing”, etc. are to be read expansively and without limitation. The methods and processes illustratively described herein suitably may be practiced in differing orders of steps, and that they are not necessarily restricted to the orders of steps indicated herein or in the claims. It is also noted that as used herein and in the appended claims, the singular forms “a,” “an,” and “the” include plural reference, and the plural include singular forms, unless the context clearly dictates otherwise. Under no circumstances may the patent be interpreted to be limited to the specific examples or embodiments or methods specifically disclosed herein. Under no circumstances may the patent be interpreted to be limited by any statement made by any Examiner or any other official or employee of the Patent and Trademark Office unless such statement is specifically and without qualification or reservation expressly adopted in a responsive writing by Applicants.

The invention has been described broadly and generically herein. Each of the narrower species and subgeneric groupings falling within the generic disclosure also form part of the invention.

The terms and expressions that have been employed are used as terms of description and not of limitation, and there is no intent in the use of such terms and expressions to exclude any equivalent of the features shown and described or portions thereof, but it is recognized that various modifications are possible within the scope of the invention as claimed. Thus, it will be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

What is claimed is:

1. A process of extraction of a particular sample among an array of samples, adsorption of DNA in the sample to a solid-phase carrier, and amplification and analysis of the DNA or storage of the DNA adsorbed to the solid phase carrier, comprising:
extraction of a particular sample in an array of samples with an extraction device containing a solid phase DNA adsorbing carrier, wherein the extraction device is identifiable among others in the extraction device array; and
moving the solid phase carrier to either an identifiable storage location first, and then to an identifiable location where the DNA can be eluted from the solid phase carrier and amplified and/or analyzed; or moving the solid phase carrier and directly to the identifiable location where the DNA can be eluted from the solid phase carrier and amplified and/or analyzed.

2. The process of claim 1 wherein the array of samples are an array of blood samples in blood tubes, and transferring blood from a blood tube to a well of a 96 well or other multi-well platform, such that it is in identifiable well.

3. The process of claim 1 wherein the array of samples are an array of blood samples in plate wells.

4. The process of claim 2, wherein a blood sample is automatically extracted by the identifiable extraction device from a blood tube and transferred to an identifiable container, which can be a well.

5. The process of claim 1 or 4 wherein the solid phase DNA adsorbing carrier is contained in a pipette.

6. The process of claim 5 wherein the pipette is one in an array of identifiable pipettes, each containing a solid phase DNA adsorbing carrier.

7. The process of claim 4, wherein after sample extraction, a tip is added to the pipette wherein the tip contains the solid phase DNA adsorbing carrier.

8. The process of claim 7 wherein the tip is released to a location for storage.

9. The process of claim 7 wherein the tip is placed in contact with a nucleic acid elution solution, and the nucleic acid is eluted.

10. A process of extraction of a particular sample among an array of samples, adsorption of DNA in the sample to a solid-phase carrier, and amplification and analysis of the DNA or storage of the DNA adsorbed to the solid phase carrier, comprising:
extraction of a particular sample in an array of samples with an extraction device containing a solid phase DNA adsorbing carrier, wherein the extraction device is identifiable among others in the extraction device array;
moving the solid phase carrier to either an identifiable storage location first, and then to an identifiable location where the DNA can be eluted from the solid phase carrier and amplified and/or analyzed; or moving the solid phase carrier and directly to the identifiable location where the DNA can be eluted from the solid phase carrier and amplified and/or analyzed; and
a tracking system tracks the stage and the sample(s) position throughout the process, and in the event of an interruption in the process, the tracking system generates a set of commands based on the system's stage and the samples' position, so that the process resumes from the interruption point forward.

11. The process of claim 10 wherein the tracking system generating the new set of commands is initiated by an operator.

12. The process of claim 11 wherein the generating the new set of commands is initiated by the operator is initiated by the operator actuating an icon.

13. The process of claim 10 further including displaying an operator-accessible view of the system's stage and the samples' position.
